(19) United States
(12) Patent Application Publication
(10) Pub. No.: US 2019/0118852 A1
(43) Pub. Date: Apr. 25, 2019

(54) VEHICLE OPERATION SYSTEM, VEHICLE OPERATION METHOD, AND STORAGE MEDIUM

(71) Applicant: HONDA MOTOR CO., LTD., Tokyo (JP)

(72) Inventors: Takeyuki Suzuki, Wako-shi (JP); Yasutaka Innami, Wako-shi (JP); Yuichi Yamazaki, Wako-shi (JP); Masahide Kobayashi, Wako-shi (JP)

(21) Appl. No.: 16/166,246

(22) Filed: Oct. 22, 2018

(30) Foreign Application Priority Data
Oct. 25, 2017 (JP) 2017-206224

(51) Int. Cl. B62D 1/183; B60K 26/02; B60T 7/02; B60K 20/02

(52) U.S. Cl. CPC B62D 1/183; B60K 26/02; G05D 1/021; B60K 20/02; B60K 2026/026; B60T 7/02

(57) ABSTRACT

There is a vehicle operation system (300) which includes a driving operating elements (302) that receive an operation of a driver for acceleration and deceleration or steering of a vehicle, and a control unit (301) that controls holding mechanisms (303) such that the driving operating elements are stored with a change in state of the holding mechanisms on the basis of an execution state of automated driving executed in a vehicle.

### CROSS-REFERENCE TO RELATED APPLICATION

Priority is claimed on Japanese Patent Application No. 2017-206224, filed Oct. 25, 2017, the content of which is incorporated herein by reference.

### BACKGROUND OF THE INVENTION

### Field of the Invention

The present invention relates to a vehicle control system, a vehicle control method, and a storage medium.

### Description of Related Art

In recent years, automated driving vehicles have been studied. In relation to this, a technology of providing a work table on a steering wheel for which an operation is unnecessary in a vehicle during automated driving is known (refer to Japanese Unexamined Patent Application, First Publication No. 2017-159684).

### SUMMARY OF THE INVENTION

However, expansion of a vehicle interior space or intervention by a driver with an operation during automated driving was not considered in the prior art.

Aspects of the present invention have been made in view of such circumstances, and an object thereof is to provide a vehicle operation system, a vehicle operation method, and a storage medium that can expand a vehicle interior space during automated driving, and realize intervention by a driver with an operation.

A vehicle operation system, a vehicle operation method, and a storage medium according to the present invention adopt the following configuration.

(1): A vehicle operation system according to one aspect of the present invention is a vehicle operation system which includes driving operating elements configured to receive an operation of a driver for acceleration and deceleration or steering of a vehicle, and a control unit configured to control a holding mechanisms on the basis of an execution state of automated driving executed in the vehicle such that the driving operating elements are stored with a change in state of the holding mechanisms of the driving operating elements.

(2): In the aspect of (1) described above, the control unit controls the holding mechanisms to move the driving operating elements to a position away from or toward a driver

(3): In the aspect of (1) described above, the control unit controls the holding mechanisms such that degrees of exposure of the driving operating elements are changed on the basis of a degree of execution of automated driving of the vehicle.

(4): In the aspect of (1) described above, the driving operating elements include at least one of a steering wheel, an accelerator pedal, a brake pedal, and an operation lever.

(5): In the aspect of (1) described above, one of the driving operating elements is a steering wheel, and the control unit controls the holding mechanisms such that the steering wheel is stored in an interior member disposed in a front direction of a front seat in a state in which a part of the steering wheel is exposed.

(6): In the aspect of (5) described above, the control unit causes the steering wheel to operate on the basis of a behavior of the vehicle.

(7): In the aspect of (6) described above, the control unit causes the steering wheel to rotate in accordance with a steering angle of a wheel of the vehicle.

(8): A vehicle operation method using an in-vehicle computer according to another aspect of the present invention is a vehicle operation method which includes causing, driving operating elements to receive an operation of a driver for acceleration and deceleration or steering of a vehicle, and controlling a holding mechanisms such that the driving operating elements are stored with a change in state of the holding mechanisms of the driving operating elements on the basis of an execution state of automated driving executed in the vehicle.

(9): A storage medium according to still another aspect of the present invention is a computer readable non-transitory storage medium which stores a program that causes an in-vehicle computer to cause driving operating elements to receive an operation of a driver for acceleration and deceleration or steering of a vehicle, and to cause a holding mechanisms to be controlled such that the driving operating elements are stored with a change in state of the holding mechanisms of the driving operating elements on the basis of an execution state of automated driving executed in the vehicle.

According to (1), (8), and (9), it is possible to expand a vehicle interior space during automated driving, and to realize intervention by a driver with an operation.

According to (2), (4), and (5), it is possible to expand a vehicle interior space.

According to (3), a driver can recognize a degree of execution of automated driving of a vehicle by looking at a degree of exposure of driving operating elements.

According to (6) and (7), a driver can recognize a behavior of a vehicle by looking at an operation of a steering wheel.

### BRIEF DESCRIPTION OF THE DRAWINGS

FIG. 1 is a configuration diagram of a vehicle control system.

FIG. 2 is a diagram which shows an example of a configuration of driving operating elements.

FIG. 3 is a diagram which shows an example of a configuration and an operation of a steering wheel.

FIG. 4 is a perspective view which shows an example of the steering wheel in a first state.

FIG. 5 is a perspective view which shows an example of the steering wheel in a second state.

FIG. 6 is a flowchart which shows an example of a flow of processing executed in a vehicle operation system.

FIG. 7 is a diagram which shows an example of a hardware configuration of the vehicle operation system.

### DETAILED DESCRIPTION OF THE INVENTION

Hereinafter, embodiments of a vehicle operation system, a vehicle operation method, and a storage medium of the present invention will be described. In the embodiments, it is assumed that the vehicle operation system is applied to an automated driving vehicle.

[Overall Configuration]

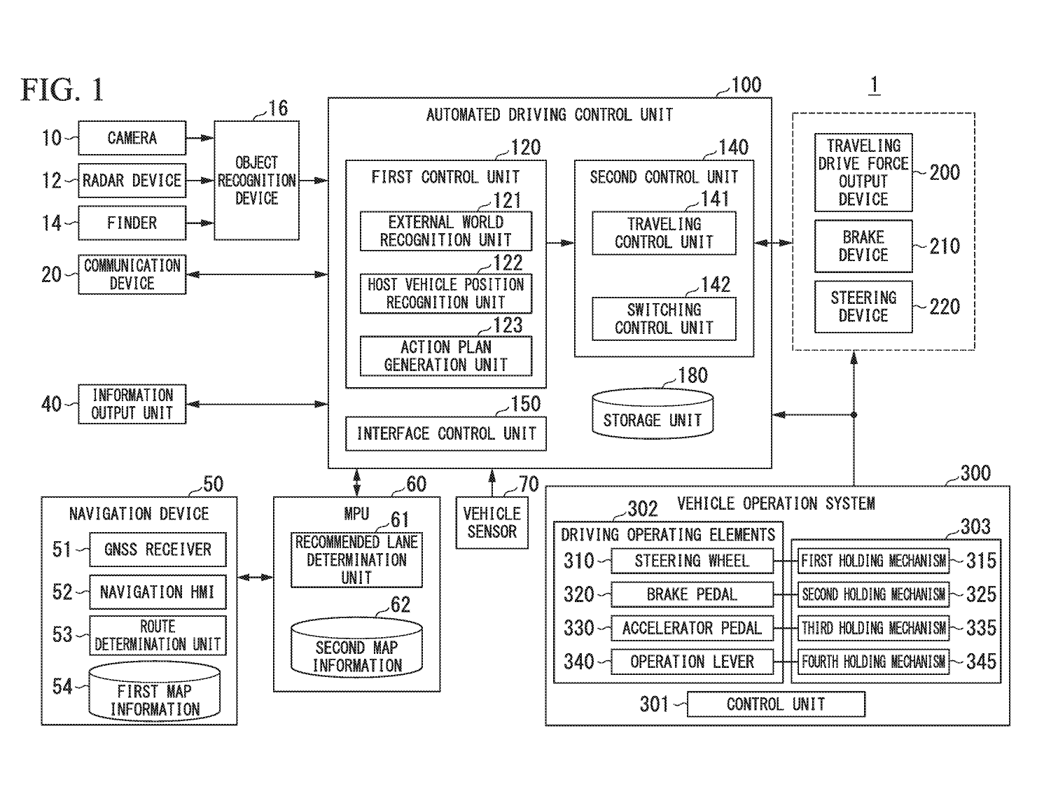

FIG. 1 is a configuration diagram of a vehicle control system 1. A vehicle in which the vehicle control system 1 is installed (hereinafter referred to as a vehicle) is, for example, a two-wheeled vehicle, a three-wheeled vehicle, or a four-wheeled vehicle, and the drive source is an internal combustion engine such as a diesel engine or a gasoline engine, an electric motor, or a combination of these. The electric motor operates using electric power generated by a power generator connected to the internal combustion engine, or discharge power of a secondary battery or a fuel cell.

The vehicle control system 1 includes, for example, a camera 10, a radar device 12, a finder 14, an object recognition device 16, a communication device 20, a vehicle interior camera 31, a microphone 32, an information output unit 40, a navigation device 50, a micro-processing unit (MPU) 60, a vehicle sensor 70, an automated driving control unit 100, a traveling drive force output device 200, a brake device 210, a steering device 220, and a vehicle operation system 300. These devices and apparatuses are connected to each other by a multiplex communication line such as a controller area network (CAN) communication line, a serial communication line, or a wireless communication network. The configuration shown in FIG. 1 is merely an example, and a part of the configuration may be omitted or other constituents may further be added.

The camera 10 is, for example, a digital camera using a solid-state imaging device such as a charge coupled device (CCD) or a complementary metal oxide semiconductor (CMOS). One or a plurality of cameras 10 are attached to arbitrary places of the vehicle in which the vehicle control system 1 is installed. For forward imaging, the cameras 10 are attached to an upper portion of a front windshield, a rear surface of a rearview mirror, and the like. For rearward imaging, the cameras 10 are attached to an upper portion of a rear windshield, a back door, and the like. For sideward imaging, the cameras 10 are attached to a door mirror, and the like. The camera 10 periodically repeats imaging of the periphery of the vehicle. The camera 10 may be a stereo camera.

The radar device 12 irradiates the periphery of the vehicle with radio waves such as millimeter waves, and detects at least a position (a distance and a direction) of an object by detecting radio waves (reflected waves) reflected by the object. One or a plurality of radar devices 12 are attached to arbitrary places of the vehicle. The radar device 12 may detect the position and a speed of an object in a frequency modulated continuous wave (FMCW) method.

The finder 14 is a light detection and ranging or laser imaging detection and ranging (LIDAR) that measures scattered light with respect to irradiation light, and detects a distance to an object. One of a plurality of finders 14 are attached to arbitrary places of the vehicle.

The object recognition device 16 performs sensor fusion processing on detection results of some or all of the camera 10, the radar device 12, and the finder 14 to recognize the position, type, speed, and the like of an object. The object recognition device 16 outputs results of the recognition to the automated driving control unit 100.

The communication device 20 communicates with other vehicles in the vicinity of the vehicle using, for example, a cellular network, a Wi-Fi network, Bluetooth (registered trademark), dedicated short range communication (DSRC), and the like, or communicates with various server devices via a radio base station. The communication device 20 communicates with a terminal device owned by a person outside the vehicle.

The information output unit 40 is, for example, various types of display devices, speakers, buzzers, and the like. The information output unit 40 outputs various types of information to a driver inside the vehicle under control of an interface control unit 150.

The navigation device 50 includes, for example, a global navigation satellite system (GNSS) receiver 51, a navigation human machine interface (HMI) 52, and a route determination unit 53, and holds first map information 54 in a storage device such as a hard disk drive (HDD) or a flash memory. The GNSS receiver specifies a position of the vehicle on the basis of a signal received from a GNSS satellite. The position of the vehicle may be specified or supplemented by an inertial navigation system (INS) using an output of the vehicle sensor 70. The navigation HMI 52 includes a display device, a speaker, a touch panel, a key, and the like. The route determination unit 53 determines, for example, a route from the position of the vehicle specified by the GNSS receiver 51 (or an arbitrary input position) to a destination input by a driver using the navigation HMI 52 (for example, including information on a transit point at the time of traveling to the destination) with reference to the first map information 54. The first map information 54 is, for example, information in which a road shape is expressed by a link indicating a road and nodes connected by a link. The first map information 54 may include curvature of a road, point of interest (POI) information, and the like. A route determined by the route determination unit 53 is output to an MPU 60. The navigation device 50 may perform route guidance using the navigation HMI 52 on the basis of a route determined by the route determination unit 53. The navigation device 50 may also be realized by, for example, a function of a terminal device such as a smartphone or a tablet terminal possessed by a user. The navigation device 50 may transmit a current position and a destination to a navigation server via the communication device 20, and acquire a route returned from the navigation server.

The MPU 60 functions as, for example, a recommended lane determination unit 61, and holds second map information 62 in the storage device such as an HDD or a flash memory. The recommended lane determination unit 61 divides a route provided from the navigation device 50 into a plurality of blocks (for example, divides the route every 100 [m] in a vehicle traveling direction), and determines a recommended lane for each block with reference to the second map information 62. The recommended lane determination unit 61 performs determination on the number of the lane from the left in which to travel. In a case that there are branch points, merging points, and the like in a route, the recommended lane determination unit 61 determines a recommended lane such that a vehicle can travel on a reasonable travel route for proceeding to a branch destination.

The second map information 62 is map information with higher accuracy than the first map information 54. The second map information 62 includes, for example, information on a center of a lane or information on a boundary of the lane. The second map information 62 may include road information, traffic regulation information, address information (addresses and postal codes), facility information, telephone number information, and the like. The road information includes information indicating a type of road such as an expressway, a toll road, a national road, and a prefectural road, the number of lanes of a road, an area of an emergency parking zone, a width of each lane, a gradient of a road, a position of a road (three-dimensional coordinates including a longitude, a latitude, and a height), curvature of a curve of a lane, positions of merging and branch points of a lane, signs provided on a road, and the like. The second map information 62 may be updated at any time by accessing other devices using the communication device 20.

The vehicle sensor 70 includes a vehicle speed sensor for detecting a speed of the vehicle at a present time, an acceleration sensor for detecting acceleration in the traveling direction of the vehicle, a yaw rate sensor for detecting an angular speed around a vertical axis, a direction sensor for detecting a direction of the vehicle, and the like. The acceleration includes, for example, at least one of longitudinal acceleration in the traveling direction of the vehicle or lateral acceleration in a lateral direction of the vehicle.

[Automated Driving Control Unit]

The automated driving control unit 100 includes, for example, a first control unit 120, a second control unit 140, an interface control unit 150, a driver instruction determination unit 170, and a storage unit 180. Each of the first control unit 120, the second control unit 140, the interface control unit 150, and the driver instruction determination unit 170 is realized by a processor such as a central processing unit (CPU) executing a program (software). Some or all of the functional units such as the first control unit 120, the second control unit 140, the interface control unit 150, and the driver instruction determination unit 170 to be described below may be realized by hardware such as large scale integration (LSI), an application specific integrated circuit (ASIC), or a field-programmable gate array (FPGA), and may also be realized by software and hardware in cooperation.

The first control unit 120 includes, for example, an external world recognition unit 121, a host vehicle position recognition unit 122, and an action plan generation unit 123.

The external world recognition unit 121 recognizes states such as a position, a speed, and acceleration of a nearby vehicle on the basis of information input from the camera 10, the radar device 12, and the finder 14 via the object recognition device 16. The position of a nearby vehicle may be represented by a representative point such as a center of gravity or a corner of the nearby vehicle, or may also be represented by an area expressed by an outline of the nearby vehicle. The state of a nearby vehicle may also include the acceleration, jerk, or a “behavior state” of the nearby vehicle (for example, whether the nearby vehicle changes or tries to change lanes).

In addition to nearby vehicles, the external world recognition unit 121 may recognize positions of guardrails, utility poles, parked vehicles, people such as pedestrians, and other objects.

The host vehicle position recognition unit 122 recognizes, for example, a lane in which the vehicle is traveling (a traveling lane), and a relative position and a posture of the vehicle with respect to the traveling lane. The host vehicle position recognition unit 122 recognizes a traveling lane by comparing a pattern of a road lane marker obtained from the second map information 62 (for example, an arrangement of solid lines and broken lines) with a pattern of a road lane marker in the vicinity of a vehicle recognized from an image captured by the camera 10. In this recognition, the position of the vehicle acquired from the navigation device 50 or a result of the processing by the INS may be added.

The action plan generation unit 123 generates an action plan for the vehicle to perform automated driving to a destination and the like. For example, the action plan generation unit 123 determines events sequentially executed in automated driving control such that the vehicle travels in a recommended lane determined by the recommended lane determination unit 61 and can cope with circumstances of the vehicle. The events in the automated driving of the first embodiment include, for example, a constant speed traveling event of traveling on the same traveling lane at a constant speed, a lane change event of changing a traveling lane of the vehicle, an overtaking event of overtaking a preceding vehicle, a following traveling event of following a preceding vehicle and traveling, a merging event of causing the vehicle to merge at a merging point, a branch event of causing the vehicle to travel in a desired direction at a branch point of a road, an emergency stop event of causing the vehicle to perform an emergency stop, a switching event of ending automated driving and switching to manual driving, and the like. During execution of these events, an action for avoidance may be planned on the basis of circumstances of the vehicle (nearby vehicles, presence of pedestrians, lane narrowing due to road construction, and the like).

The action plan generation unit 123 generates a target trajectory on which the vehicle will travel in the future. The target trajectory includes, for example, a speed element. For example, the target trajectory has a plurality of future reference times set for each predetermined sampling time (for example, about several tenths of a [sec]) and is generated as a set of target points (orbit points) to be reached at these reference times. For this reason, a wide interval between trajectory points indicates that the vehicle travels a section between the trajectory points at a high speed.

The action plan generation unit 123 generates, for example, candidates of a plurality of target trajectories, and selects an optimum target trajectory that conforms to a route to a destination at that time in view of safety and efficiency.

The second control unit 140 includes, for example, a traveling control unit 141 and a switching control unit 142. The traveling control unit 141 controls the traveling drive force output device 200, the brake device 210, and the steering device 220 such that the vehicle passes by a target trajectory generated by the action plan generation unit 123 at a scheduled time.

The switching control unit 142 switches a driving mode of the vehicle on the basis of an action plan generated by the action plan generation unit 123. For example, the switching control unit 142 switches the driving mode from manual driving to automated driving at a scheduled start point of the automated driving. The switching control unit 142 switches the driving mode from the automated driving to the manual driving at a scheduled end point of the automated driving.

At the time of the manual driving, input information from driving operating elements 302 are output to the traveling drive force output device 200, the brake device 210, and the steering device 220. The input information from the driving operating elements 302 may also be output to the traveling drive force output device 200, the brake device 210, and the steering device 220 via the automated driving control unit 100. Each electric control unit (ECU) of the traveling drive force output device 200, the brake device 210, and the steering device 220 performs each operation on the basis of the input information from the driving operating elements 302 and the like.

The interface control unit 150 causes the information output unit 40 to output a traveling state of the vehicle at the time of the automated driving or manual driving, a timing at which switching between the automated driving and the manual driving is performed, a notification of a request and the like for causing a driver to perform the manual driving, and the like. The interface control unit 150 may cause the information output unit 40 to output a determination result of the driver instruction determination unit 170.

The storage unit 180 is a storage device such as a hard disk drive (HDD), a flash memory, a random access memory (RAM), or a read only memory (ROM). The storage unit 180 stores information on automated driving control of the embodiment.

The traveling drive force output device 200 outputs a traveling drive force (torque) for the vehicle to travel to driving wheels. The traveling drive force output device 200 includes, for example, a combination of an internal combustion engine, an electric motor, and a transmission, and an ECU that controls them. The ECU controls the above constituents according to information input from the traveling control unit 141 or information input from the driving operating elements 302.

The brake device 210 includes, for example, brake calipers, a cylinder that transmits hydraulic pressure to the brake calipers, an electric motor that causes the cylinder to generate hydraulic pressure, and a brake ECU. The brake ECU controls the electric motor according to the information input from the traveling control unit 141 or the information input from the driving operating elements 302, and braking torque in accordance with a braking operation is output to each wheel. The brake device 210 may include a mechanism which transmits hydraulic pressure generated by an operation of the brake pedal 320 included in the driving operating elements 302 to the cylinder via a master cylinder as a backup. The brake device 210 is not limited to the constituent described above, and may also be an electronic control-type hydraulic pressure brake device which controls an actuator according to the information input from the traveling control unit 141 and the information input from the driving operating elements 302, and transmits hydraulic pressure of the master cylinder to the cylinder. The brake device 210 may also include brake devices of a plurality of systems in consideration of a safety aspect.

The steering device 220 includes, for example, a steering ECU and an electric motor. The electric motor changes, for example, a direction of a steering wheel by applying a force to the rack and pinion mechanism. The steering ECU drives an electric motor according to the information input from the traveling control unit 141 or the information input from the driving operating elements 302, and causes the direction of a steering wheel to be changed. The steering device 220 acquires steering angle information output from the first drive unit 312 provided in a steering wheel 310 to be described below, and causes the direction of a steering wheel to be changed on the basis of the acquired steering angle information.

[Vehicle Operation System]

The vehicle operation system 300 includes, for example, a control unit 301, the driving operating elements 302, and a holding mechanisms 303.

The control unit 301 is realized by a processor such as a CPU executing a program (software). The control unit 301 may be realized by hardware such as LSI, an ASIC, or an FPGA, and may also be realized by software and hardware in cooperation.

The control unit 301 controls the holding mechanisms 303 with a change in a state of the holding mechanisms 303 of the driving operating elements 302 on the basis of an execution state of automated driving executed in a vehicle. The control unit 301 controls the holding mechanisms 303 to move the driving operating elements 302 to a position away from a driver P or a position toward the driver P.

The control unit 301 monitors, for example, the driving mode switched by the switching control unit 142 of the second control unit 140. The control unit 301 determines a degree of execution of the automated driving. In a case that it is determined that the driving mode is switched, the control unit 301 controls the holding mechanisms 303 such that a degree of exposure of driving operating elements are changed on the basis of the degree of execution of the automated driving by the automated driving control unit 100.

The control unit 301 may change a degree of exposure of the driving operating elements 302, for example, on the basis of the degree of execution of automated driving in the driving mode of a vehicle such as a manual mode, a semi-automated driving mode, a traffic jam pilot (TJP) mode, or a fully automated driving mode. The degree of exposure is, for example, represented by a value of a ratio of a maximum movement amount to a movement amount in a process of transition from the second state of the holding mechanisms 303 to the first state.

The driving operating elements 302 receive operations of a driver for acceleration and deceleration or steering of a vehicle. The driving operating elements 302 are held in an interior of a vehicle by the holding mechanisms 303, and the attachment states are changed. The holding mechanisms 303 are controlled by the control unit 301, and cause positions of the driving operating elements 302 to be changed on the basis of the driving mode of a vehicle.

The driving operating elements 302 include, for example, the steering wheel 310, the brake pedal 320, an accelerator pedal 330, an operation lever 340, and other operators. The holding mechanisms 303 include, a first holding mechanism 315, a second holding mechanism 325, a third holding mechanism 335, and a fourth holding mechanism 345. The control unit 301 controls, for example, each of the first holding mechanism 315, the second holding mechanism 325, the third holding mechanism 335, and the fourth holding mechanism 345.

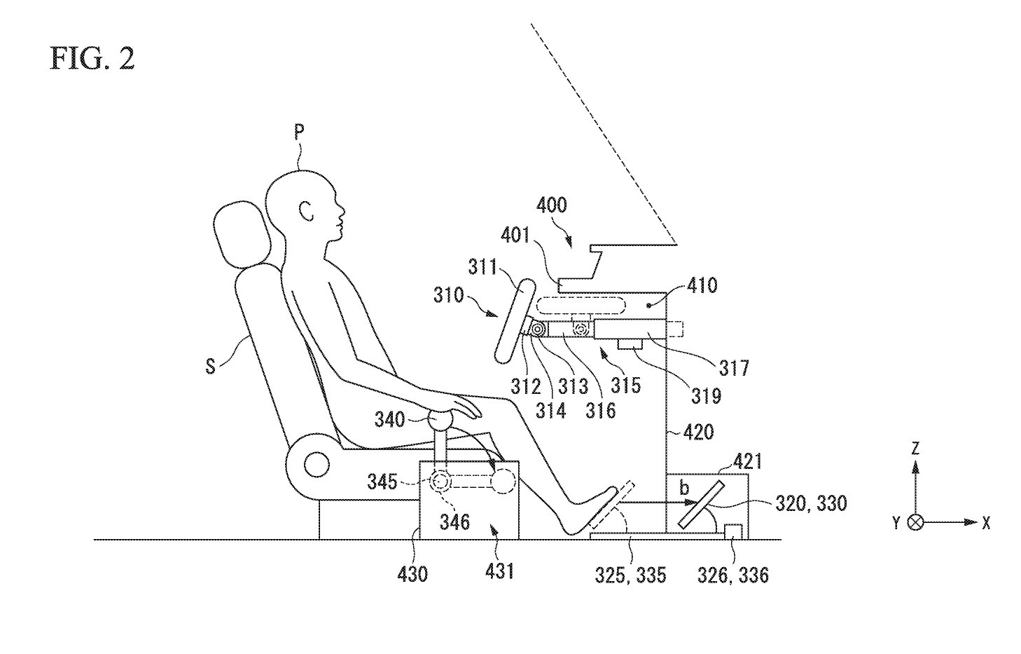

FIG. 2 is a diagram which shows an example of a configuration of the driving operating elements 302. The steering wheel 310 is an operating element for receiving an operation of the steering of a vehicle by the driver P during manual driving. The steering wheel 310 is controlled by the traveling control unit 141 via the steering device 220 during automated driving. The steering wheel 310 is held in the interior of a vehicle by the first holding mechanism 315.

The steering wheel 310 is stored in a storage space 410 of an interior member such as a dashboard 400 disposed in a front direction (an X-axis direction) of a front seat S according to an operation of the first holding mechanism 315. The storage space 410 may also be provided in, for example, an interior garnish, an instrument panel, and the like, in addition to a dashboard.

The brake pedal 320 is an operating element for receiving a braking operation of a vehicle by the driver during manual driving. The brake pedal 320 is controlled by the traveling control unit 141 via the brake device 210 during automated driving. The brake pedal 320 is held to be slidable in the X-axis direction by the second holding mechanism 325. The brake pedal 320 is stored in a storage space 421 provided in a bulk head 420 disposed in the front direction of the front seat S (the X-axis direction) according to an operation of the second holding mechanism 325.

The second holding mechanism 325 includes a drive unit 326. The drive unit 326 is controlled by the control unit 301 and the brake pedal 320 is caused to move in the X-axis direction. The brake pedal 320 is controlled by the control unit 301 and is stored in the storage space 421. The position of the brake pedal 320 in a manual driving mode is set as a first state of the brake pedal 320, and a state of the brake pedal 320 stored in the storage space 421 is set as a second state of the brake pedal 320. The control unit 301 changes, for example, the position of the brake pedal 320 from the first state of the brake pedal 320 to the second state of the brake pedal 320 in a case that it is determined that a vehicle is in an automated driving mode.

The accelerator pedal 330 is an operating element for receiving an operation for speed adjustment of a vehicle by the driver during manual driving. The accelerator pedal 330 is controlled by the traveling control unit 141 via the traveling drive force output device 200 during automated driving. The accelerator pedal 330 is held to be slidable in the X-axis direction by the third holding mechanism 335.

The accelerator pedal 330 is stored in storage space 421 provided in the bulk head 420 disposed in the front direction (the X-axis direction) of the front seat S according to an operation of the third holding mechanism 335. The drive unit 336 is controlled by the control unit 301, and causes the accelerator pedal 330 to move in the X-axis direction. The accelerator pedal 330 is controlled by the control unit 301 and is stored in the storage space 421.

A position of the accelerator pedal 330 in the manual driving mode is set as a first state of the accelerator pedal 330, and a state in which the accelerator pedal 330 is stored in the storage space 421 is set as a second state of the accelerator pedal 330. The control unit 301 changes the position of the accelerator pedal 330 from the first state of the accelerator pedal 330 to the second state of the accelerator pedal 330 in a case that it is determined that a vehicle is in the automated driving mode.

The operation lever 340 is an operating element for receiving an operation such as a gear change of a vehicle by a driver during manual driving. The operation lever 340 is controlled by the traveling control unit 141 via a transmission and the like during automated driving. The operation lever 340 is held to be rotatable around a rotation axis along a Y-axis by the fourth holding mechanism 345. The operation lever 340 is stored in an interior member provided in a floor tunnel 430 and the like disposed to be adjacent to the front seat S by an operation of the fourth holding mechanism 345.

The driver unit 346 is controlled by the control unit 301 and causes the operation lever 340 to rotate around the rotation axis along the Y axis. The operation lever 340 is controlled by the control unit 301, and can be stored in the storage space 421. It is stored in the storage space 431 in the floor tunnel 430.

A position of the operation lever 340 in the manual driving mode is set as a first state of the operation lever 340, and a state in which the operation lever 340 is stored in the storage space 431 is set as a second state of the operation lever 340. The control unit 301 changes, for example, the position of the operation lever 340 from the first state of the operation lever 340 to the second state of the operation lever 340 in a case that it is determined that the vehicle is in the automated driving mode. Although the operation lever 340 is disposed on a right side of the driver P in FIG. 2, it may also be disposed on a left side.

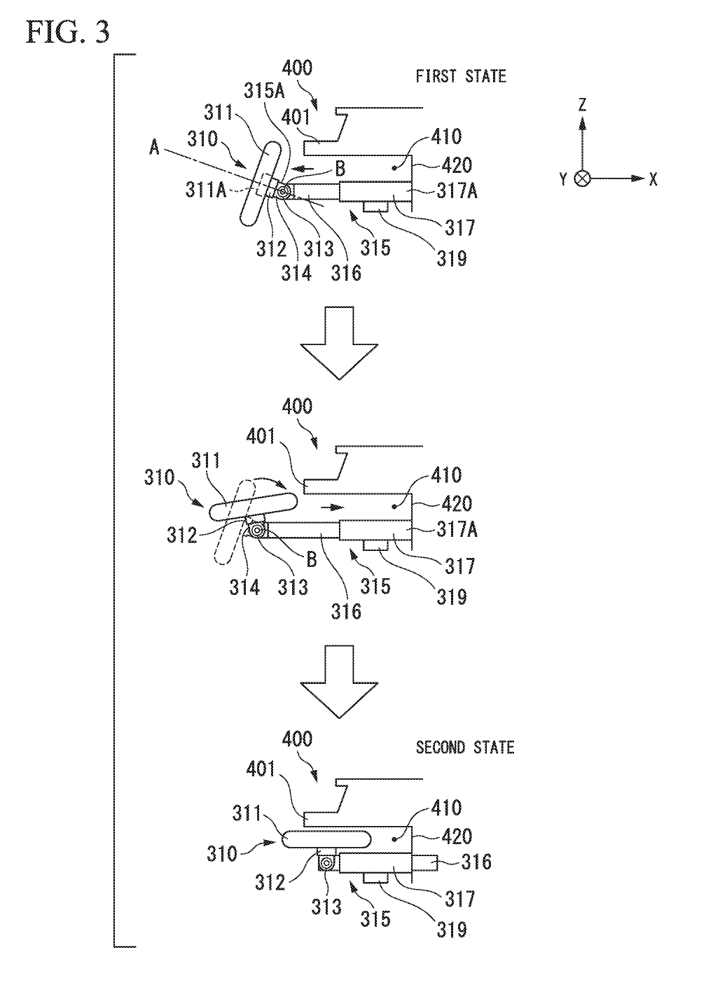

Next, a device configuration of the steering wheel 310 will be described in detail. FIG. 3 is a diagram which shows an example of a configuration and an operation of the steering wheel 310. The steering wheel 310 is supported in the interior of a vehicle by the first holding mechanism 315. The first holding mechanism 315 is attached, for example, to the bulk head 420 provided in a foot space of the interior of a vehicle in the traveling direction of the vehicle (the X-axis direction).

The steering wheel 310 includes a steering wheel rim 311, a hub 311A, the first drive unit 312, a second drive unit 313, and a support portion 314.

The first holding mechanism 315 includes a steering shaft 316, a rail portion 317, and a third drive unit 319.

The steering wheel rim 311 is, for example, an operation member formed in an annular shape. In the first state of the steering wheel 310, the front surface of the steering wheel rim 311 directly faces the driver P. The driver P performs an operation to causes the steering wheel rim 311 to rotate around a rotation axis A, causes a steering mechanism of a vehicle to operate, and adjusts the traveling direction of the vehicle. An output axis of the first drive unit 312 is connected to a center of a rear surface side of the hub 311A disposed in a center of the steering wheel rim 311.

The first drive unit 312 drives the steering wheel rim 311 and the hub 311A to be rotatable around the rotation axis A. In a case that the driver P performs a rotation operation on the steering wheel rim 311 at the time of manual driving, the first drive unit 312 applies a reaction force in a rotation direction opposite to a rotation direction of the rotation operation.

For example, a stepping motor or the like is used as the first drive unit 312. The first drive unit 312 also detects, for example, a rotation angle around the rotation axis A of the steering wheel rim 311. The rotation angle is calculated by a command value input to the stepping motor. The detection of the rotation angle may also be performed by using a potentiometer or the like.

A rear surface side of the first drive unit 312 is attached to the support portion 314 provided at a tip 315A of the steering shaft 316 of the first holding mechanism 315. As a result, the steering wheel rim 311 is supported by the first holding mechanism 315 via the support portion 314. The support portion 314 is, for example, a hinge mechanism which supports the steering wheel rim 311, the hub 311A, and the first drive unit 312 to be rotatable around a rotation axis B along a direction (the Y-axis direction) orthogonal to the rotation axis A.

The second drive unit 313 is attached to the support portion 314 concentrically with the rotation axis B. The second drive unit 313 is controlled by the control unit 301. For example, a stepping motor is used as the second drive unit 313. The second drive unit 313 drives the steering wheel rim 311, the hub 311A, the first drive unit 312, and the support portion 314 to be rotatable around the rotation axis B. As a result, the steering wheel 310 is driven to be rotatable around the rotation axis B by the second drive unit 313.

With the configuration described above, a tilt angle of the steering wheel rim 311 is adjusted around the rotation axis B with respect to the first holding mechanism 315. The steering shaft 316 of the first holding mechanism 315 is, for example, held to be slidable in the X-axis direction with respect to the rail portion 317. A rear end 317A of the rail portion 317 is fixed to the bulk head 420. The steering shaft 316 is, for example, formed in a rod shape, but may also be formed in a plate shape. Any rail portion 317 may be used as long as it can support and cause the steering shaft 316 to slide.

The steering shaft 316 is driven in a sliding direction by the third drive unit 319. The third drive unit 319 drives, for example, the steering shaft 316 via a gear. The third drive unit 319 may be a linear motor or a hydraulic actuator. With such configuration, the first holding mechanism 315 becomes a telescopic mechanism of the steering wheel rim 311. That is, the steering wheel rim 311 is controlled such that it moves in the X-axis direction by the control unit 301.

With the configuration described above, the steering wheel 310 is supported to be rotatable around the rotation axis A and the rotation axis B by the first holding mechanism, and is supported to be slidable in the X-axis direction. Then, the steering wheel 310 is controlled by the control unit 301 such that it rotates around the rotation axis A and the rotation axis B, and moves in the X-axis direction.

Next, an operation of the steering wheel 310 will be described. As shown in an upper part of FIG. 3, the steering wheel 310 is disposed at a position of the first state in which the driver P operates during manual driving (refer to FIG. 2). If a vehicle is switched from the manual driving mode to the automated driving mode, the first state transits to the second state via a state shown in the middle of FIG. 3. In the state shown in the middle of FIG. 3, first, the third drive unit 319 causes the first holding mechanism 315 to extend in a direction in which the steering shaft 316 approaches the driver P. As a result, the steering wheel 310 moves in the direction toward the driver P as compared with the first state.

Then, the second drive unit 313 causes the steering wheel 310 to rotate around the rotation axis B such that a front surface of the steering wheel 310 faces upward (in a Z-axis direction) as compared with the first state. At this time, since the steering shaft 316 is extended, it is avoided that the steering wheel rim 311 interferes with an end portion 401 of the dashboard 400.

Thereafter, as shown at a bottom of FIG. 3, the third drive unit 319 causes the first holding mechanism 315 to be shortened in a direction in which the steering shaft 316 moves away from the driver P. As a result, the steering wheel 310 moves in the direction away from the driver P as compared with the firs state. Then, the first steering wheel 310 is stored in the storage space 410 provided in the dashboard 400, and is in the second state.

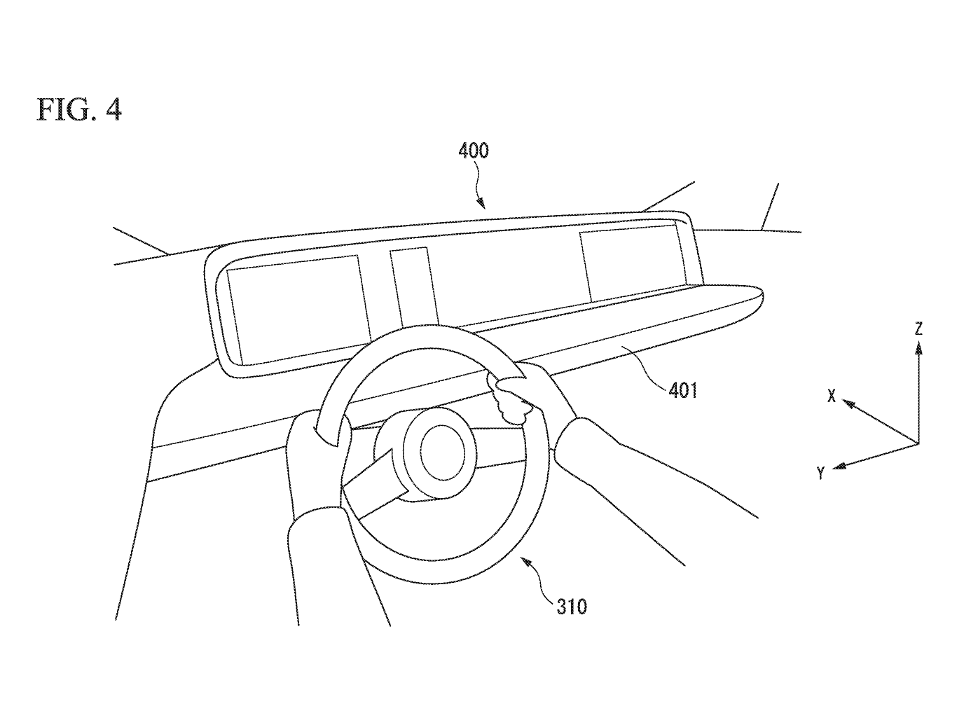

Next, control of the steering wheel 310 in the automated driving mode will be described. FIG. 4 is a perspective view which shows an example of the steering wheel 310 in the first state. The control unit 301 drives the first holding mechanism 315 such that the steering wheel 310 in the first state is stored in the storage space 410 of the dashboard 400 disposed in a front direction of a front seat, and causes the steering wheel 310 to be in the second state in which a part of the steering wheel rim 311 is exposed in a case that it is determined that a vehicle is switched to the automated driving mode.

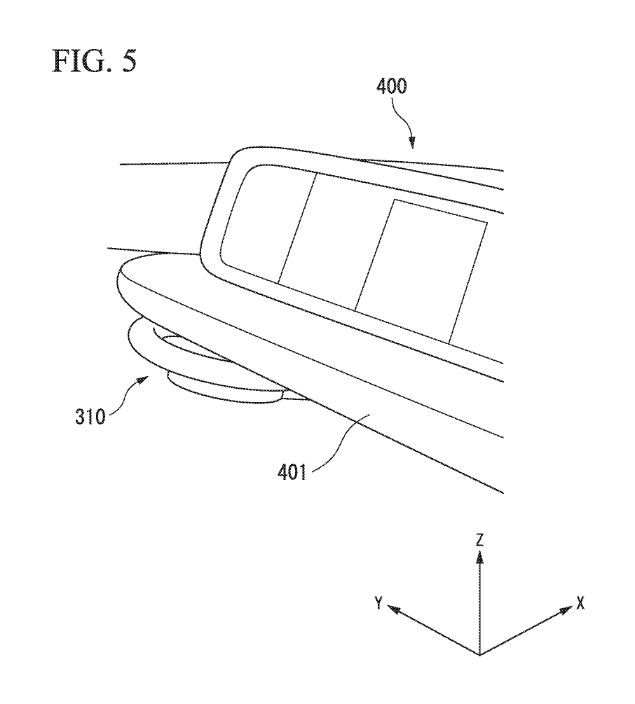

FIG. 5 is a perspective view which shows an example of the steering wheel 310 in the second state. In the second state, the control unit 301 may causes the steering wheel 310 to operate on the basis of a behavior of a vehicle. The control unit 301 may acquire information on the behavior of a vehicle on the basis of an output result of the vehicle sensor 70, and cause the steering wheel 310 to rotate in accordance with a steering angle of a wheel of a vehicle included in the acquired information. That is, the steering wheel 310 in the second state is controlled by the control unit 301, and may also be used as an indicator for the steering angle of the wheel in the automated driving mode.

The steering wheel 310 in the second state may receive an operation by the driver P. For example, in a case that it is determined that assistance of a driver is required for steering in automated driving, an operation of the driver with respect to the steering wheel 310 in the second state may be received, and an operation of override by the driver P may also be received. Override is, for example, that a driver switches a driving mode from automated driving to manual driving on his/her own will.

The steering wheel 310 may be changed the degree of exposure according to the degree of automated driving in the driving mode such as the manual mode, the semi-automated driving mode, the traffic jam pilot (TJP) mode, or the fully automated driving mode by the control unit 301. The degree of automated driving is higher in order of the manual mode, the semi-automated driving mode, the traffic jam pilot (TJP) mode, and the fully automated driving mode. For example, the control unit 301 may decrease the degree of exposure as the degree of automated driving increases in the case of a low speed follow-up traveling.

For example, the steering wheel 310 is maintained in the first state in the manual mode, and is maintained in the second state in the fully automated driving mode. Then, the steering wheel 310 may be maintained at a positon of a third state between the first state and the second state in the semi-automated driving mode, and may be maintained at a position of a fourth state between the third state and the second state.

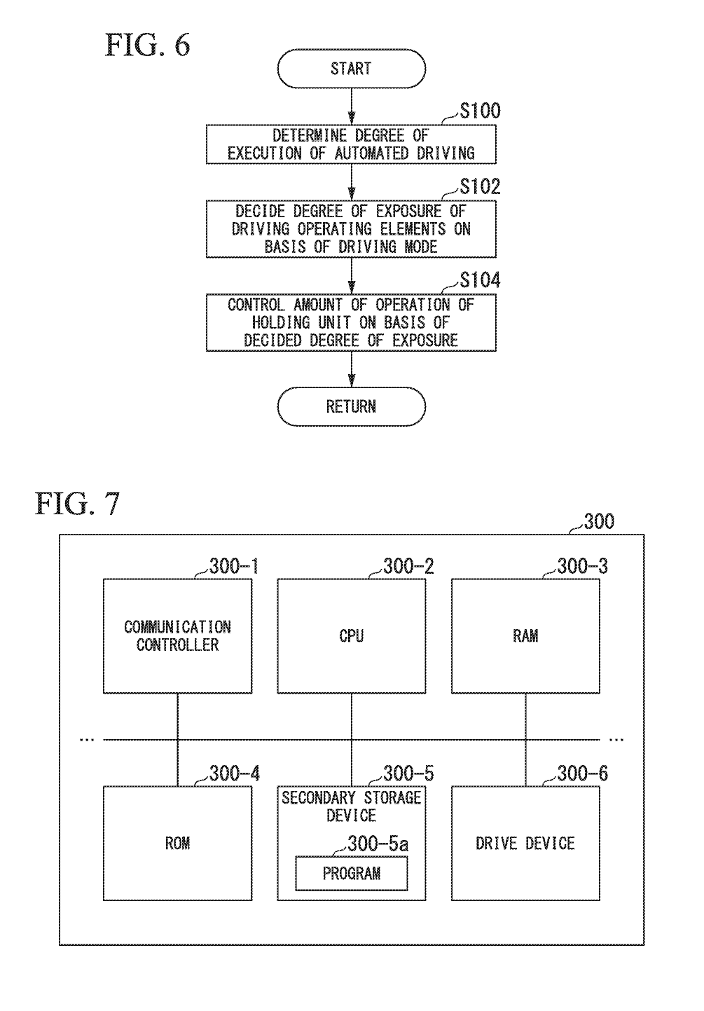

Next, processing of the vehicle operation system 300 will be described. FIG. 6 is a flowchart which shows an example of a flow of processing executed in the vehicle operation system 300. The control unit 301 monitors the driving mode switched by the switching control unit 142, and determines a degree of automated driving (step S100). The control unit 301 determines the degree of exposure of the steering wheel 310 on the basis of the determined driving mode (step S102).

The control unit 301 controls a movement amount of the first holding mechanism 315 on the basis of the determined degree of exposure, and causes the steering wheel 310 to move to the position away from the driver P or the position toward the driver P (step S104).

According to the embodiment described above, the vehicle operation system 300 can expand a vehicle interior space during automated driving, and realize an intervention by the driver P with the operation. The vehicle operation system 300 can change the degree of exposure of the driving operating elements 302 on the basis of the degree of execution of automated driving, and cause the driver P to recognize the degree of execution of automated driving. The vehicle operation system 300 can cause the steering wheel 310 to operate on the basis of the behavior of a vehicle, thereby setting the steering wheel 310 as an indicator for the behavior of a vehicle.

[Hardware Configuration]

The vehicle operation system 300 of the embodiment described above is realized by a configuration of hardware as described in FIG. 7. FIG. 7 is a diagram which shows an example of a hardware configuration of the vehicle operation system 300 of the embodiment.

The vehicle operation system 300 is configured to have a communication controller 300-1, a CPU 300-2, a RAM 300-3, a ROM 300-4, a secondary storage device 300-5 such as a flash memory or an HDD, and a drive device 300-6 connected to one another by an internal bus or a dedicated communication line. The drive device 300-6 is mounted with a portable storage medium such as an optical disc. A program 300-5a stored in the secondary storage device 300-5 is developed to the RAM 300-3 by a DAM controller (not shown), and the like, and executed by the CPU 300-2, and thereby the vehicle operation system 300 is realized. A program to which the CPU 300-2 refers may be stored in a portable storage medium mounted on the drive device 300-6, and may be downloaded from another device via a network NW.

The above embodiment can be expressed as follows.

A vehicle operation system is configured to include a storage device, and a hardware processor which executes a program stored in the storage device, in which the hardware processor, by executing the program, causes driving operating elements to receive an operation of a driver for acceleration and deceleration or steering of a vehicle, and control the holding mechanisms such that the driving operating elements are stored with a change in state of holding mechanisms of the driving operating elements on the basis of an execution state of automated driving executed in the vehicle.

As described above, although a mode for executing the present invention has been described using an embodiment, the present invention is not limited to the embodiment, and various modifications and substitutions can be made within a scope not departing from the gist of the present invention. For example, although the steering wheel 310 has been shown as control for the degree of exposure of the driving operating elements 302 in the embodiment described above, similar control may also be applied to another driving operating elements 302.

What is claimed is:

1. A vehicle operation system comprising:
driving operating elements configured to receive an operation of a driver for acceleration and deceleration or steering of a vehicle; and
a control unit configured to control holding mechanisms on the basis of an execution state of automated driving executed in the vehicle such that the driving operating elements are stored with a change in state of the holding mechanisms of the driving operating elements.

2. The vehicle operation system according to claim 1,
wherein the control unit controls the holding mechanisms to move the driving operating elements to a position away from or toward a driver.

3. The vehicle operation system according to claim 1,
wherein the control unit controls the holding mechanisms such that degrees of exposure of the driving operating elements are changed on the basis of a degree of execution of automated driving of the vehicle.

4. The vehicle operation system according to claim 1,
wherein the driving operating elements include at least one of a steering wheel, an accelerator pedal, a brake pedal, and an operation lever.

5. The vehicle operation system according to claim 4,
wherein one of the driving operating elements is a steering wheel, and
the control unit controls the holding mechanisms such that the steering wheel is stored in an interior member disposed in a front direction of a front seat in a state in which a part of the steering wheel is exposed.

6. The vehicle operation system according to claim 5,
wherein the control unit causes the steering wheel to operate on the basis of a behavior of the vehicle.

7. The vehicle operation system according to claim 6,
wherein the control unit causes the steering wheel to rotate in accordance with a steering angle of a wheel of the vehicle.

8. A vehicle operation method using an in-vehicle computer, comprising:
causing, driving operating elements to receive an operation of a driver for acceleration and deceleration or steering of a vehicle, and
controlling holding mechanisms such that the driving operating elements are stored with a change in state of the holding mechanisms of the driving operating elements on the basis of an execution state of automated driving executed in the vehicle.

9. A computer readable non-transitory storage medium which stores a program that causes an in-vehicle computer
to cause driving operating elements to receive an operation of a driver for acceleration and deceleration or steering of a vehicle, and
to cause holding mechanisms to be controlled such that the driving operating elements are stored with a change in state of the holding mechanisms of the driving operating elements on the basis of an execution state of automated driving executed in the vehicle.
